(19) United States
(12) Patent Application Publication
(10) Pub. No.: US 2008/0103955 A1
(43) Pub. Date: May 1, 2008

(54) ACCOUNTING FOR TRUSTED PARTICIPANTS IN AN ONLINE ADVERTISING EXCHANGE

(75) Inventors: Gary W. Flake, Bellevue, WA (US); Brett D. Brewer, Sammamish, WA (US); Christopher A. Meek, Kirkland, WA (US); David Max Chickering, Bellevue, WA (US); Jody D. Biggs, Redmond, WA (US); Ewa Dominowska, Kirkland, WA (US); Brian Burdick, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/864,481

(22) Filed: Sep. 28, 2007

Related U.S. Application Data
(60) Provisional application No. 60/862,969, filed on Oct. 25, 2006.

(51) Int. Cl. G06Q 30/00; G06F 17/30; G06F 17/40; G06Q 20/00

(52) U.S. Cl. 705/37; 705/400

(57) ABSTRACT

For a multi-party advertising exchange including advertising and publishing entities from disparate advertising networks, flexible advertising transaction accounting methods are provided for circumstances where a relatively small number of trusted participants agree to reduce onerous reporting requirements conducted at a per transaction level. Trusted participants optionally report aggregate data for transactions including aggregate fraud data measurements to determine aggregate apportioning of cost and payments associated with advertising transactions. Aggregate reporting, subject to safeguards, enables a reduction in the overhead associated with per transaction accounting, and other participants need not duplicate measurements of trusted participants who are positioned best to collect the measurements, enabling a cooperative effort to the benefit of all of the trusted participants.

### CROSS REFERENCE TO RELATED APPLICATIONS

This application claims priority to U.S. Patent Application Ser. No. 60/862,969, filed on Oct. 25, 2006, entitled “DISTRIBUTED ARCHITECTURES FOR ONLINE ADVERTISING”, the entirety of which is incorporated herein by reference.

### TECHNICAL FIELD

For online advertising architectures and environments, the subject disclosure relates to techniques for reducing transactional accounting overhead and complexity for a subset of participants having an enhanced trust level with respect to one another.

### BACKGROUND

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. For instance, Google is signing up publishers into their AdSense ad network to broker publishing space from the publishers to a set of participating advertisers bidding for and purchasing the advertising space. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because, as a broker for advertising deals, they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network due to legal restrictions when signing up, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

Still further, today, reporting and accounting requirements for advertising transactions are carried out at the transaction level, i.e., the amounts due to the market makers, publishers, middlemen, etc. from the advertisers are determined as a function of parameters applying to a single event, i.e., a customer click, a search result listing, etc. as dictated by pay per click, pay per impression or like billing models. Due to large numbers of transactions that can occur at a large publisher's site on a given day, however, tracking all of this data is an enormous task. In addition, different parties to the exchange are positioned differently, with some more capable than others at measuring certain information about the transaction. Thus, each transaction must be recorded and reported to and by each of the parties correctly if the transaction fees are to be apportioned appropriately, and if each of the parties is to ensure it is not the victim of fraud.

As a consequence, such systems inherently create a complex accounting headache, e.g., when a single advertisement might receive millions of clicks in a single day and statistics are being tracked across many advertisements from different advertisers according to different ways to allocate risk from an agreement standpoint, the amount of data to be processed, stored and reported can be daunting, to say the least. At the macro level, one can see that this sort of transaction level recording and reporting does not scale very well.

Moreover, click fraud complicates matters further by introducing an inherent layer of distrust into reported data, and sometimes by those who may even have a conflict of interest with respect to the reported data. For instance, with a CPC billing model, the advertiser only pays when a click occurs. However, often the advertiser is poorly positioned to understand whether the click is fraudulent or not, whereas a publisher can better determine the validity of clicks. In such a case, the publisher thus has an incentive to validate clicks, particularly where it is unclear, because the publisher will be paid for all validated clicks. Any party that receives money because of clicks as part of a billing model thus also has an incentive to commit fraud for short-term gain.

Different billing models allocate risks among the advertiser and publisher entities differently, but fraud concerns remain. For instance, cost per impression billing models are also subject to fraud concerns. Swinging the risk to the publisher side is another transaction based advertising payment model where the advertiser only pays when an actual sale results, e.g., when a customer is acquired. In such a case, the advertiser knows best when an actual customer is acquired, but has an incentive to deflate the numbers of customers acquired in a way that the publisher may not be able to detect.

Thus, at bottom, to implement safeguards against fraud in an online advertising system that predicates billing on per transaction costs, each party must take extra steps at considerable expense. This is on top of considerable overhead associated with tracking and determining what micro financial debt is owed or profit is due from each transaction. What is thus desired is a simpler way to implement accounting for certain kinds of online advertising transactions where full transactional detail is not required.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

For a multi-party advertising exchange including advertising and publishing entities from disparate advertising networks, the invention provides flexible advertising transaction accounting methods for circumstances where a relatively small number of trusted participants agree to relax reporting requirements normally conducted at a per transaction level. The invention allows trusted participants optionally to report aggregate data for transactions including aggregate fraud data measurements to determine aggregate apportioning of cost and payments associated with advertising transactions. Aggregate reporting, subject to safeguards, enables a reduction in the overhead associated with per transaction accounting, and other participants need not duplicate measurements of trusted participants who are best positioned to collect the measurements, enabling a cooperative effort to the benefit of all of the trusted participants.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the accounting techniques for use by a trusted set of participants in an online advertising environment in accordance with the present invention are further described with reference to the accompanying drawings in which:

FIG. 1 illustrates an exemplary online advertising exchange environment in which the present invention can be implemented;

FIG. 2A illustrates an exemplary per transaction set of billing terms applied to an agreement formed in an online advertising exchange;

FIG. 2B illustrates representative different sets of knowledge understood by different participants of an online advertising ecosystem about user events occurring that trigger the billing model in accordance with a non-limiting aspect of the invention;

FIG. 3 illustrates a trusted advertising services layer 302 for use by a set of participants that trust one another for aggregate transaction reporting in accordance with the invention;

FIG. 4 illustrates a sliding scale of risk that shifts between advertiser, publisher, market makers or other middlemen as part of a variety of per transaction billing models to which the invention can apply;

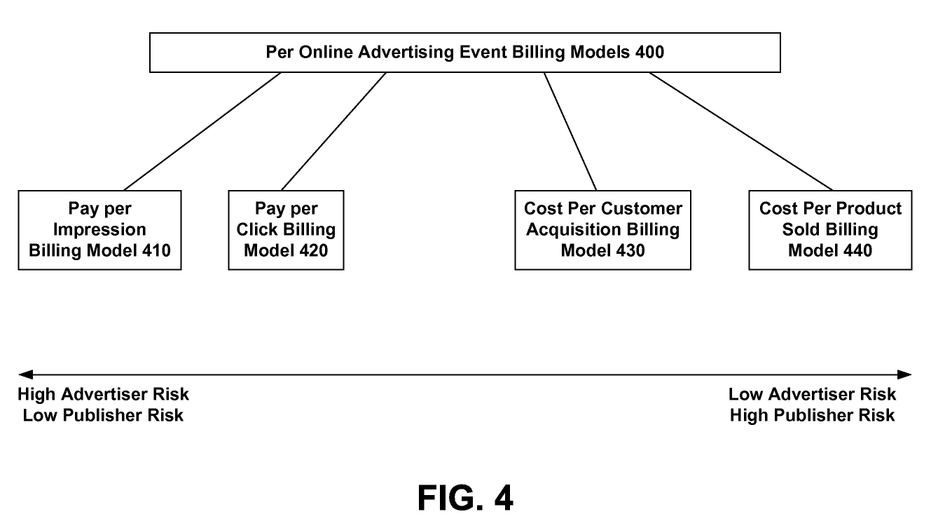

FIG. 5 illustrates exemplary different sets of knowledge understood about qualifying user actions and different knowledge of the potential for fraud in the transaction in accordance with aggregate measurements in accordance with the invention;

FIG. 6 illustrates exemplary aspects of the trusted reporting cooperation layer that reduces reporting overhead, addresses fraud efficiently and streamlines payments by avoiding micro transactional costs associated with per transaction billing models in accordance with the invention;

FIG. 7 is a block diagram exemplifying the application of benchmarks to aggregate data in order to determine any disparities between reported data and actual performance or fraud trends in accordance with the invention;

FIG. 8 is a flow diagram showing an exemplary, non-limiting process for forming a group of trusted participants in an exchange in accordance with the invention;

FIGS. 9A and 9B illustrate exemplary transaction totaling and statistical representation, respectively, for reporting aggregate data to an online advertising exchange in accordance with the invention;

FIG. 10A illustrates a block diagram showing various different stages from formation of a group of trusted participants to apportionment of payments based on aggregate reported data in accordance with the invention;

FIG. 10B is a flow diagram illustrating an exemplary, non-limiting process for batching reporting processes for transacting within the context of an online advertising auction held by an advertising exchange in accordance with the invention;

FIG. 11 is a block diagram of a computing system environment suitable for use in implementing the present invention;

FIG. 12 illustrates a distributed architecture for online advertising, according to embodiments of the present invention;

FIG. 13 illustrates one example of the flow of data within an exemplary non-limiting architecture according to embodiments of the present invention;

FIG. 14 illustrates a flowchart of the operation of an exchange, according to exemplary, non-limiting embodiments of the present invention; and

FIG. 15 illustrates a flowchart of the operation of matching bids to asks in an exemplary online advertising exchange.

### DETAILED DESCRIPTION

### Overview

In various non-limiting embodiments, the invention is described in the context of a distributed architecture for online advertising, i.e., a market mechanism that manages the exchange of advertising goods among multiple participants on the advertising and/or publishing side, and across disparate advertising networks that today are exclusive of one another as described in the background. In consideration of the present limitations and lack of scalability of per transaction accounting and click fraud risk, the invention provides improved accounting techniques for participants in an advertising exchange where there is an elevated level of trust among the participants.

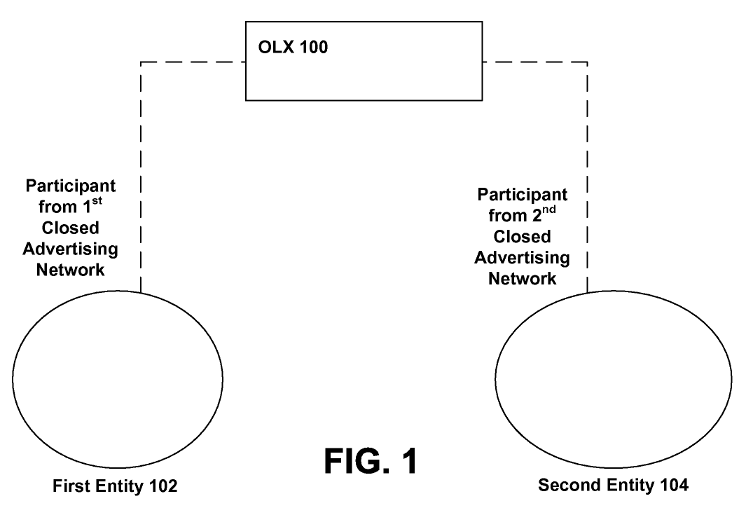

In general, an exchange 100 in accordance with the invention is illustrated in FIG. 1, including a participant 102, such as an advertiser broker or publisher broker from a first closed advertising network and a participant 104, such as an advertiser broker or publisher broker from a first closed advertising network, who are able to come together via federated advertising exchange 100. Exchange 100 operates to match advertising inventory (e.g., ads) with publisher inventory (e.g., web sites) as part of an online bidding process, completing one or more transactions between buyers and sellers of advertising. More about a federated online advertising exchange, such as exchange 100, as an exemplary implementation environment for the invention is described below. The invention is not limited to entities 102 and 104 being advertising brokers or publisher brokers, but rather entities 102 and 104 may also be exchanges, whereby exchange 100 becomes an exchange of exchanges.

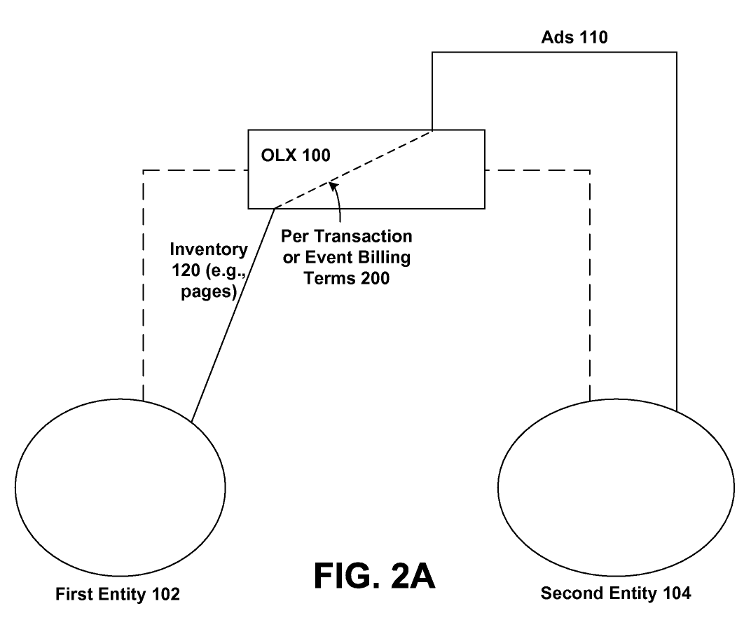

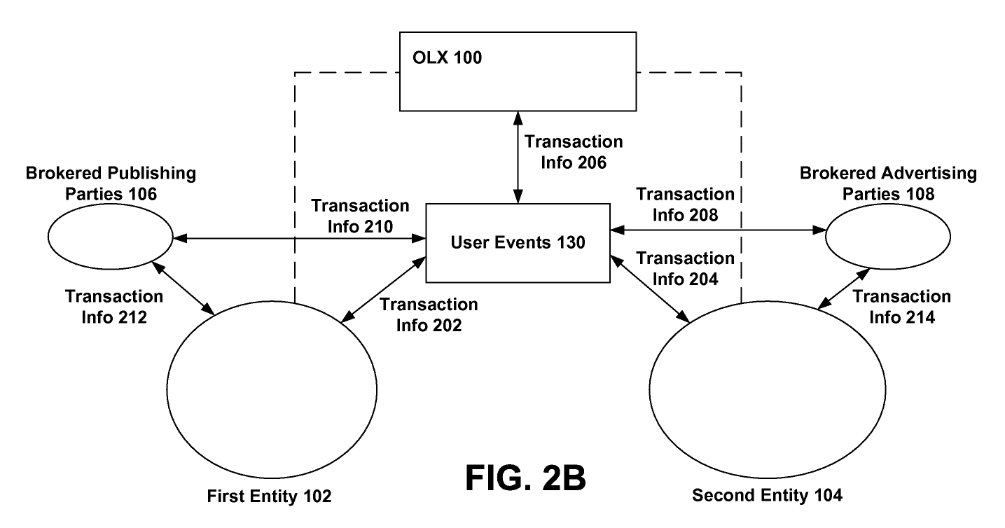

As shown in FIG. 2A, when a transaction that matches ads 110 from entity 104 and inventory 120 of entity 102 is conducted in exchange 100, a variety of information, though often not perfect information, is understood by each of the parties about the transaction. For one, a set of billing terms is set as part of matching ads 110 to inventory 120. Today, these are set according to per transaction terms 200. Per transaction terms 200 define how money is apportioned among the various participants in online advertising transactions upon the occurrence of each event that triggers the transaction terms 200. Generally, each of the parties will understand what event triggers a monetization event. For instance, a CPC model results in monetization when a click occurs. However, different participants will have different information about actual clicks as they occur in the future.

This concept is illustrated further in FIG. 2B. Upon the occurrence of user events 130, such as entering search terms, or clicking on an advertisement, in order to properly award the cost of the advertising event to the appropriate publishing entities, market makers, etc., a variety of information is recorded, such as, but not limited to, when the event occurred, from what machine the request occurred, whether the event resulted in a sale or customer, how long the user spent at the target content, information about the user, etc. Such information may or may not all be directly relevant to the transaction model upon which the cost apportionment is based, but may also be relevant to future advertising efforts, and to detecting fraud on the event, such as click fraud. Thus, for instance, first entity 102 may be a publisher broker and second entity 104 may be an advertiser broker.

Upon the occurrence of user events 130, different parties are today positioned differently with respect to the online event to understand the exact nature of the user events 130. For instance, first entity 102 may understand information 202 about the user event 130, second entity 104 may understand a different subset 204 of the total information available about user event 130. In turn, OLX 100 may understand another subset 206 of the total information.

Moreover, first entity 102 may be representing one or more brokered publishing parties 106 who ultimately display the advertisement at issue. Those brokered publishing parties 106 will in turn know other information about the user event 130, either directly as part of transaction information 210, or indirectly as part of information sharing with publisher broker 102 represented by transaction info 212. Similarly, second entity 104 may be representing one or more brokered publishing parties 108 who ultimately display the advertisement at issue. Those brokered publishing parties 108 will also know other information about the user event 130, either directly as part of transaction information 208, or indirectly as part of information sharing with publisher broker 102 represented by transaction info 214.

However, the problem today is that each party, by itself, attempts to know the maximum information possible about user events 130, so that the party can validate, for instance, that the party is not being victimized by click fraud. Yet, this is very inefficient and adds to the overall cost of the advertising ecosystem. The invention recognizes that where two parties trust one another because both benefit from cooperation, then those two parties can apportion the tasks of transaction reporting in a much more efficient manner. For instance, a publisher is often in good position to understand user behavior prior to an event, and an advertiser may be in good position to understand user behavior after an event occurs. Together, a cooperative set of reporting by the publisher and advertiser provides each other with enough information to understand the event without requiring transaction level details in the case of every transaction by both the publisher and the advertiser.

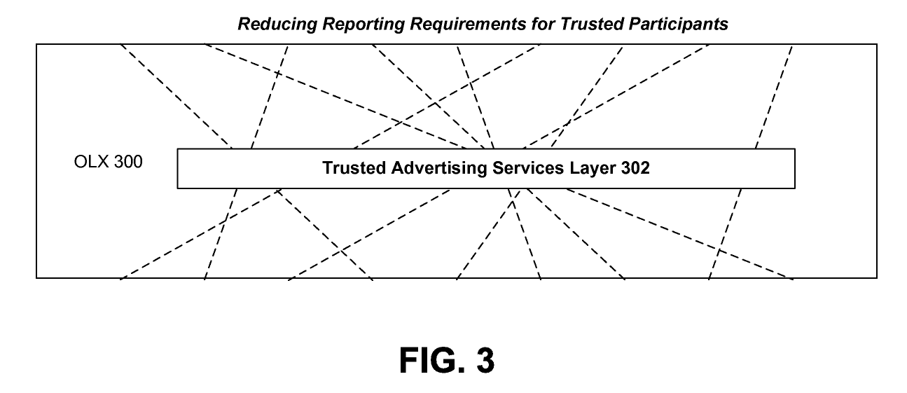

Accordingly, in various non-limiting embodiments, the invention provides infrastructure for an on-line advertising marketplace for a subset of parties, e.g., 2 or more, to engage under trusted reporting circumstances, whereby the parties that are best positioned to collect information about fraud are designated to collect such information. As shown in FIG. 3, the infrastructure can be manifested as part of an advertising exchange 300 by providing a layer 302 where a set of trusted parties can organize according to different reporting requirements than the rest of the transactions conducted in the exchange.

Periodically, such as at the end of each day, aggregate totals for transactions for the period are reported, either as a direct calculation by those best positioned to provide the aggregate totals, or on a statistical basis, e.g., a publisher might report for the day that an average of X clicks per hour were recorded for an advertiser's advertisement with a likelihood of no more than 3% clicks resulting from fraud. Such aggregate totals or statistical reporting substantially alleviates onerous reporting requirements and safeguarding against fraud that are imposed in an untrusted environment.

Moreover, benchmarks can also be implemented to compare aggregate reported data with other similar or like data as a deterrent against defrauding a trusted partner. In other words, OLX 300 observes a lot of transactional information and thus can oversee a lot of transactional data. Where aberrant statistical data is observed in the reported data, an investigation can ensue. Where a trusted partner is found to engage in fraud knowingly, severe penalties can be applied to the offending party. Advantageously, by merely reporting aggregate totals, rather than all details surrounding a transaction, in some cases, a participant can keep competitive information secret that the participant may not otherwise wish to disclose.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follows.

### Supplemental Context Relating to Click Fraud

For further background about click fraud, to understand why alleviating some parties from complex tracking of the necessary information can be of greater good to a common set of trusted parties, click fraud is a type of Internet crime that occurs in pay per click online advertising when a person, automated script, or computer program imitates a legitimate user of a web browser clicking on an ad, for the purpose of generating a charge per click without having actual interest in the target of the ad's link.

In a simple form, CPC advertising, also sometimes referred to as pay per click (PPC), advertising is an arrangement in which operators of Web sites, acting as publishers, display clickable links from advertisers, in exchange for a charge per click. As mentioned, there are also a number of advertising networks, which act as middlemen between publishers and advertisers. Each time a Web user clicks on an advertisement, assumed valid, the advertiser pays the advertising network, which in turn pays the publisher a share of this money. Due to the assumption that each click is a valid click from a potential customer, this revenue sharing system provides an incentive for click fraud.

The largest of the advertising networks act in a dual role, since they are not only advertisers, but also publishers themselves, e.g., on their search engines, which presents an issue of whether this complex relationship creates a conflict of interest. For instance, while Google loses money to undetected click fraud when it pays out to the publisher, it makes more money when it collects fees from the advertiser. Because of the spread between what Google collects and what Google pays out, click fraud directly and invisibly results in profits for Google.

In addition to those who knowingly or unknowingly directly profiteer from click fraud as part of the advertising model, a secondary source of click fraud is non-contracting parties, who are not part of any pay-per-click agreement. This type of fraud is even harder to police because perpetrators generally cannot be sued for breach of contract or charged criminally with fraud. Examples of non-contracting parties are:

Competitors of advertisers: These parties may wish to harm a competitor who advertises in the same market by clicking on their ads. The perpetrators do not profit directly, but force advertisers to pay for irrelevant clicks thus weakening or eliminating a source of competition.

Competitors of publishers: These parties may wish to frame a publisher by making it look like the publisher is clicking on its own ads. The advertising network may then terminate the relationship. Many publishers rely exclusively on revenue from advertising and thus, this kind of attack can threaten a publishers' business.

Other malicious intent: As with vandalism, there is an array of motives for wishing to cause harm to either an advertiser or a publisher, even by people who have nothing to gain financially. Motives include political and personal vendettas. These cases are often troubling since it is hard to track down the culprit, and if found, there is little legal action that can be taken against them.

Unwanted “friends” of the publisher: Sometimes, upon learning a publisher profits from ads being clicked, a supporter of the publisher, like a fan, family member, or personal friend, will click on the ads to “help.” However, this can backfire when the publisher, not the “friend” is accused of click fraud.

Advertising networks try to stop fraud by all parties, but due to the difficulty of inquiring into human intent, often cannot know which clicks are legitimate. Moreover, where fraud is not committed by the publisher, it is hard to know who should pay when past click fraud is found. Publishers resent having to pay refunds for something that is not their fault. However, advertisers are adamant that they should not have to pay for phony clicks.

Click fraud can be as simple as one person starting a small web site, becoming a publisher of ads, and clicking on those ads to generate revenue. Often the number of clicks and their value is so small that the fraud goes undetected.

Much larger scale fraud also occurs. Those engaged in large-scale fraud will often run scripts that simulate a human clicking on ads in web pages. However, huge numbers of clicks appearing to come from just one, or a small number of computers, or a single geographic area, look highly suspicious to the advertising network and advertisers. Clicks coming from a computer known to be that of a publisher also look suspicious to those watching for click fraud. A person attempting large-scale fraud, alone in their home, stands a good chance of being caught.

One type of fraud that circumvents detection based on IP patterns is one that uses existing user traffic, turning this into clicks or impressions. Such an attack can be camouflaged from users, e.g., by using 0-size iframes to display advertisements that are programmatically retrieved using JavaScript. It could also be camouflaged from advertisers and portals by ensuring that so-called reverse spiders are presented with a legitimate page, while human visitors are presented with a page that commits click-fraud. The use of 0-size iframes and other techniques involving human visitors may also be combined with the use of incentivized traffic, where members of “Paid to Read” (PTR) sites are paid small amounts of money, often a fraction of a cent, to visit a website and/or click on keywords and search results, sometimes hundreds or thousands of times every day. Some owners of PTR sites are also members of PPC engines, and may send many email ads to users who do search, while sending few ads to those who do not. They do this mainly because the charge per click on search results is often the only source of revenue to the site. This is known as “forced searching,” a practice that is generally frowned upon for obvious reasons.

Other more sophisticated fraud perpetrators have many computers with their own Internet connections in different geographic locations. Often scripts fail to mimic true human behavior, so organized crime networks use Trojan code to turn unsuspecting user machines into zombie computers. The zombie computer, using sporadic redirects or DNS cache poisoning, can turn the oblivious user's actions into actions generating revenue for the scammer.

Impression fraud is an insidious variant of click fraud in which the advertiser is penalized for having an unacceptably low click-through rate for a given keyword. This involves making numerous searches for a keyword, but without clicking of the advertisement. Such advertisements then become disabled automatically, enabling a competitor's lower-bid ad for the same keyword to continue while several high bidders on the first page of the search results are eliminated.

Proving click fraud can be very difficult, since it is hard to know who is behind a computer and what their intentions are. Often the best an advertising network can do is to identify which clicks are most likely fraudulent and not charge the account of the advertiser. There are other, even more sophisticated means of detection, but none are currently foolproof, especially where the fraud is perpetrated from a lot of different user machines.

Specifically, it has been shown that there is no conceptual definition of invalid clicks that can be operationalized except for certain obviously clear cases. An operational definition cannot be fully disclosed to the general public because of the concerns that unethical users will take advantage of it, which may lead to a massive click fraud. However, if it is not disclosed, advertisers cannot verify or even dispute why they have been charged for certain clicks. Despite the difficulties, a number of companies are developing viable solutions for click fraud identification and are developing intermediary relationships with advertising networks. Such solutions generally fall into two categories:

Forensic analysis of advertisers' web server log files. This analysis of the advertiser's web server data requires an in-depth look at the source and behavior of the traffic. As industry standard log files are used for the analysis, the data is verifiable by advertising networks. The problem with this approach is that it relies on the honesty of the middlemen in identifying fraud.

Third party corroboration. Third parties offer web-based solutions that might involve placement of single-pixel images or Javascript on the advertiser's web pages and suitable tagging of the ads. The visitor may be presented with a cookie. Visitor information is then collected in a third-party data store and made available for download. The better offerings make it easy to highlight suspicious clicks and they show the reasons for such a conclusion. Since an advertiser's log files can be tampered with, however, their accompaniment with corroborating data from a third party forms a more convincing body of evidence to present to the advertising network. However, the problem with third-party solutions is they see only part of the traffic of the entire network. Hence, they can less likely identify patterns that span several advertisers. In addition, due to the limited amount of traffic they receive, when compared to middlemen, they can be overly or less aggressive when judging traffic to be fraud.

Thus, at bottom, to implement safeguards against fraud in an online advertising system that predicates billing on per transaction costs, each party must take considerable extra steps and expense in order to determine properly all of the different parameters associated with determining what debt or profit is owed due to each transaction and to implement sufficient safeguards against click fraud. The invention thus provides a simpler way to implement accounting for online advertising transactions where trust is present.

### Reduced Accounting Complexity for Trusted Participants

As mentioned, a big inhibitor in online advertising auctions is the ability to track results accurately by everyone once a transactional billing model is selected. When all parties are untrusted as part of a generalized advertising exchange, at first glance, it appears that all parties must collect their own data about user events to the extent possible in order to ensure proper payment is made, neither more than less than should be. An advertising exchange, by its very nature, helps to ensure that each party receives its proper apportionment of funds, however, on some level, the advertising exchange relies on accurate information being provided to it in order for the results to be correct: fraud in=fraud out.

Accordingly, today, each party attempts to collect the maximum information about each transaction in order to help protect itself against fraud from other participants knowingly or unknowingly reporting incorrect information and/or event generators (users) creating misleading information. In addition, event and billing logs have enormous storage and processing requirements due to voluminous per transaction information that must be stored in order to capture tremendous volumes of advertising transactions that take place in a given day. Accordingly, the invention provides improved accounting techniques for participants in an advertising exchange where there is an elevated level of trust among the participants.

Generally speaking, on-line advertising billing models 400 tend to follow per event or per transaction terms. Many of these billing models 400 are well understood in the online advertising industry, such as pay per impression models 410, pay per click models 420, cost per acquiring a customer models 430, cost per sale models 440, etc. Since no one can predict the future performance of an advertisement with perfect precision, each of the different billing models 400 shift risk on a sliding scale from terms that are risky for advertisers to terms that represent high publisher risk. Different kinds of costs pertain as well based on expected value and return calculations performed by the parties.

In any event, the selected per transaction terms define how and when payment is to occur. However, as mentioned collecting all of the detail associated with every transaction by every party is not an efficient way to conduct business when trusted parties are involved. When interacting with multitudinous parties, it is difficult to understand who may be committing fraud and who might not be, and so each party in such an untrusted system attempts to measure all data down to the microcosmic details in order to make sure they are being treated fairly in the system. When two parties who have a long term interest in cooperation trust one another in such an advertising system, computational efficiency results in not only sharing information each other is competent in collecting but also by batching transactions to minimize transaction costs.

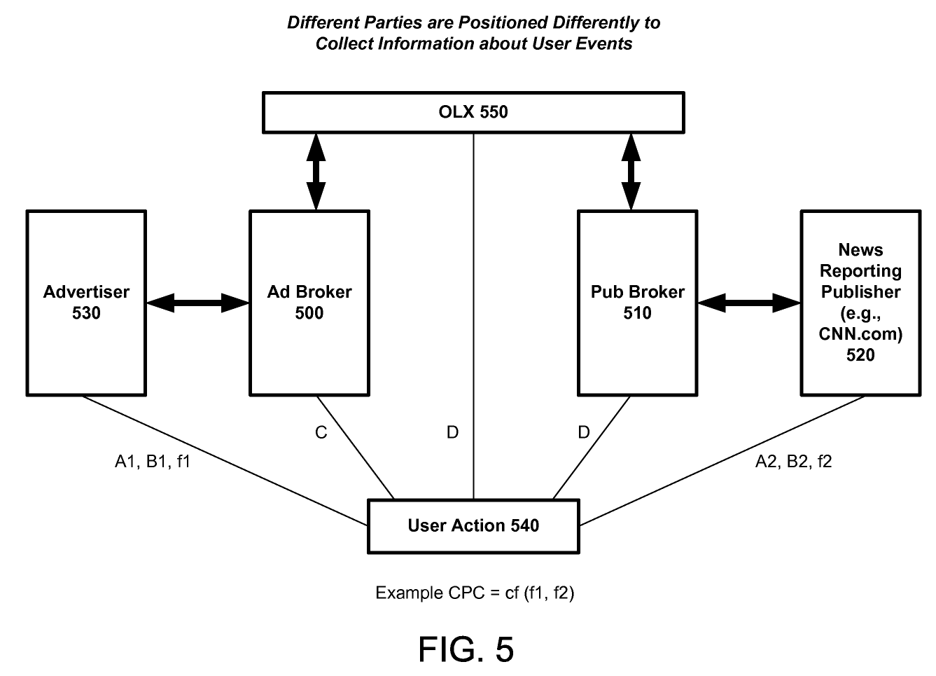

Accordingly, as shown in the non-limiting conceptual example of FIG. 5, some statistics are easier to collect by some parties than by others. For instance, in a relatively simple exchange advertisement agreement, an advertiser 530 via broker 500 buys publishing space on new reporting publisher 520 (e.g., CNN.com) through publisher broker 510 (e.g., Yahoo.com). OLX 550 handles the match between advertiser 530 and publisher 520 and sets terms according to a cost per click billing model. As a fictional example, suppose CPC for each transaction was impacted by click fraud in the following hypothetical way:

Actual CPC=Measured CPC*cf(f1,f2)

where cf (f1, f2) is a click fraud function of fraud measurements f1 and f2. As shown in FIG. 5, it may be that advertiser 530, ad broker 500, pub broker 510 and publisher 520 all trust one another and thus allow those parties who are best at collecting the variables provide them. For instance, advertiser 530 may be best at collecting and reporting measurement f1 about clicks 540 and publisher 520 may be best at collecting f2.

In such case, it makes sense to allow the trusted parties to agree to reduce transaction costs associated with per transaction accounting in an untrusted environment, and instead in accordance with the invention, provide aggregate or statistical totals to one another with respect to the measured variables. In an alternate embodiment, probabilistic totals are used, until an actual or more accurate accounting can be performed. Then, later, if a discrepancy between predicted and actual occurs, a reconciliation of moneys among the affected parties can occur.

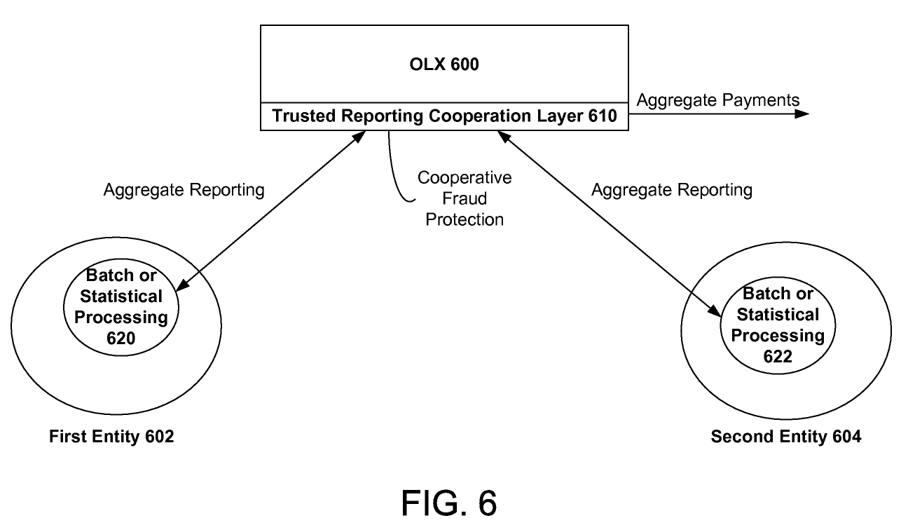

In addition, the trusted environment for parties established by participants in accordance with the invention provides enhanced fraud protection via trusted reporting cooperation layer 610 of OLX 600 as shown in FIG. 6. Since all participants, such as first entity 602 and second entity 604, provide their best measurements of all of the relevant fraud metrics, cooperative fraud protection is thus achieved via the layer, and aggregate payments also reduce computational overhead by avoiding micropayments associated with each transaction.

Since the relevant fraud metrics can be provided in aggregate by batch or statistical processing components 620 and 622 of first entity 602 and second entity 604, respectively, in accordance with the invention, fraud can be computed approximately or accurately on a global scale, or as a probability affecting transactions, an assumption that can be examined later, and reconciled if need be. For instance, instead of calculating the probability of click fraud with respect to every click, an aggregate click fraud measurement can be recorded and reported so that it can be assumed that a percentage of clicks will be fraudulent based on the aggregate click fraud measurement. In this regard, anti-fraud calculations on a per transaction basis are tedious and thus an area ripe for optimizing the collection and reporting of fraud measurements among parties.

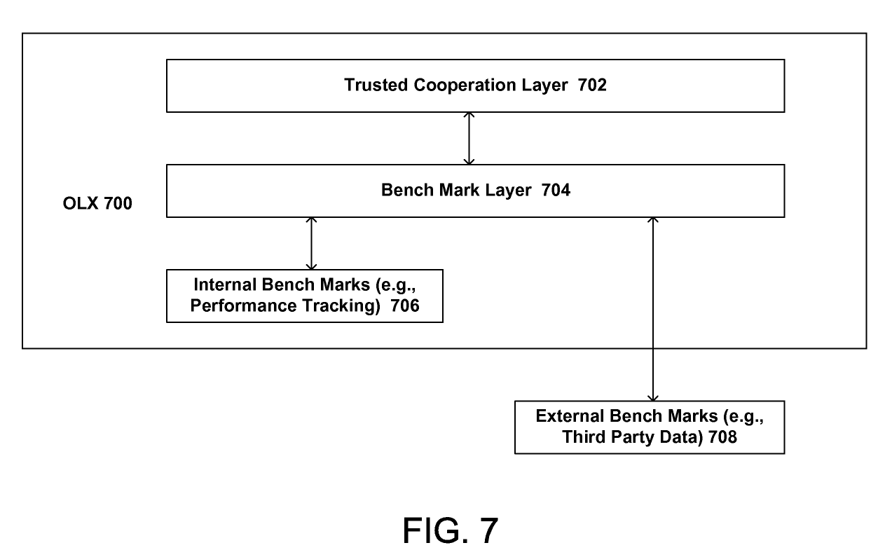

FIG. 7 illustrates an optional component of the invention that may be integrated with or cooperate with trusted cooperation layer 702 of OLX 700 in accordance with the invention. A bench mark layer 704 can be provided which helps to periodically check that the aggregate, statistical or probabilistic data upon which layer 702 operates to bill the trusted parties is not aberrant from some bench mark being measured, either internally elsewhere in the exchange 700, e.g., via internal bench marks 706, such as data from a performance tracking component that measures performance across all advertisements in the exchange 700 or via external bench marks 708, e.g., performance data or click fraud probabilities measured by objective third parties.

In this way, even though there is trust between the parties to support aggregate payments without reporting all of the detail, there is also some degree of check on the system whereby the parties can detect clearly aberrant statistics, and request an audit in such cases. For instance, each party may be required to store transactional data for one day, or one week, just in case a third party wishes to audit based on severely aberrant data. By incorporating some benchmark, there is some check against reality that reported results in aggregate make sense, and to make sure instances of fraud are not being under or over estimated.

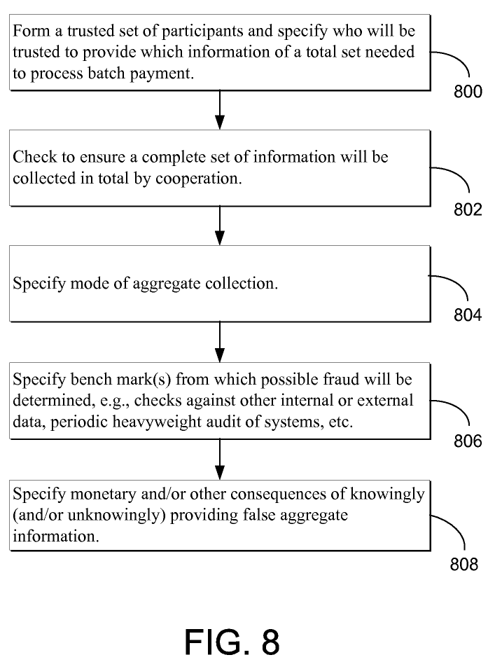

FIG. 8 is a flow diagram illustrating an exemplary formation of a trusted subset, e.g., two or more parties, of an online advertising exchange who agree that their long term goals are consistent with maintaining trust with respect to each other who is best positioned to measure transactions occurring with respect to an online advertising pay per transaction billing environment, and to measure fraud metrics with respect to possibly fraudulent user actions, such as fraudulent clicks. At 800, a trusted set of participants identifies itself to the exchange as a subset of trusted parties who wish to avail themselves of aggregate reporting to ease administrative overhead of per transaction accounting. As part of forming a trusted set of participants, it is specified which parties will be responsible for providing which information of a total set of information need to process aggregate payments. At 802, a check is made to ensure that a complete set of information will be collected, i.e., to check that the information in aggregate is in fact not insufficient to make aggregate calculations. At 804, the participants can specify a mode for aggregate collection, e.g., batch totaling, statistical representation, such as average and standard deviation of some metric, for a day's transactions, probabilistic representation, such as percent probability of click fraud within 5% degree of confidence, etc. At 806, the parties can specify one or more bench marks to apply to aggregate reports as a periodic check that the numbers being reported are reasonable estimates. At 808, as an additional safeguard, the set of trusted parties can agree to punitive measures should anyone of them knowingly and/or unknowingly commit fraud under such a heightened trust arrangement.

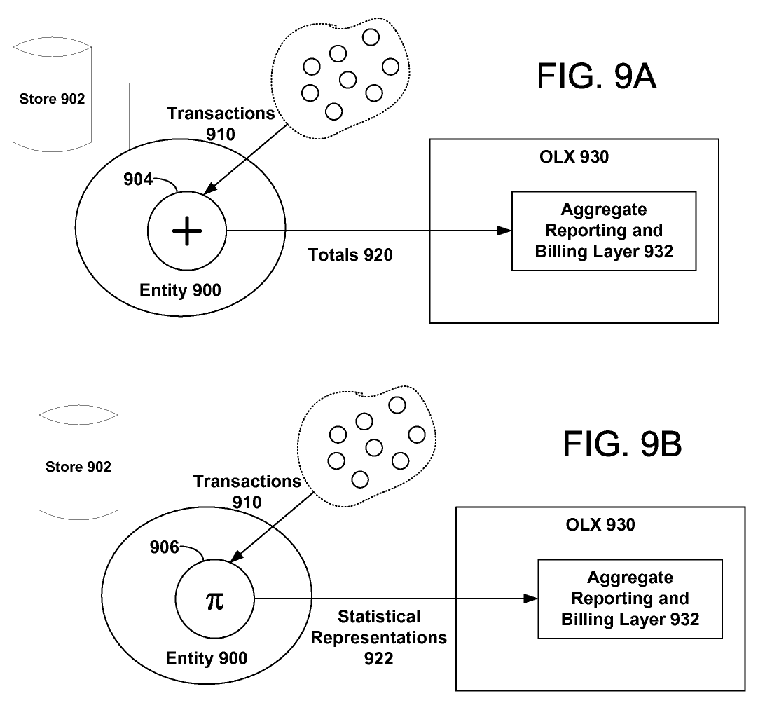

FIGS. 9A and 9B illustrate batching and statistical modeling, respectively, for metrics reported by parties according to the trusted arrangement of the invention. In this regard, in FIG. 9A, an entity 900 observes various metrics on transactions 910 and totals them with adder 904 to report the totals 920 to aggregate reporting and billing layer 932 of OLX 930. A store 902 can temporarily merely store all of the individual transactions 910 in order to maintain some transaction level data to audit if need be. Such store 902 need only store a small recent amount of data to be useful as an ultimate check on fraudulent reporting, so that aberrant results observed by comparison to bench marks can be confirmed or dispelled. In this regard, the ability to delete vast quantities of transaction data and merely report a set of running metrics, and simultaneously benefit from trusted metrics of other participants, yields a cooperative solution that enables all of the trusted participants to benefit.

FIG. 9B similarly illustrates processing of transactions 910, except instead of totals, statistical or probabilistic representations 922 are reported by entity 900 to aggregate reporting and billing layer 932. In either case, by batching, or reducing to statistics, large number of transactions, the participants enjoy an enormous savings in processing, storage and network traffic as well as benefit from other participants' optimally recorded metrics. Such savings are worth elevating one's trust with respect to other trusted participants, particularly where such trust already exists, and the bench marking enables an additional layer of oversight to ensure everyone stays the trusted path over time, by immediately flagging potential abuse of trust.

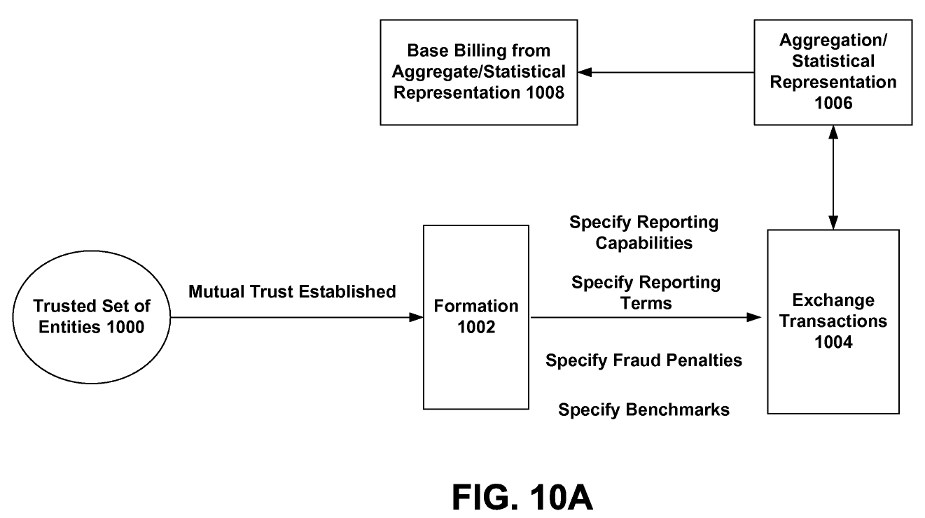

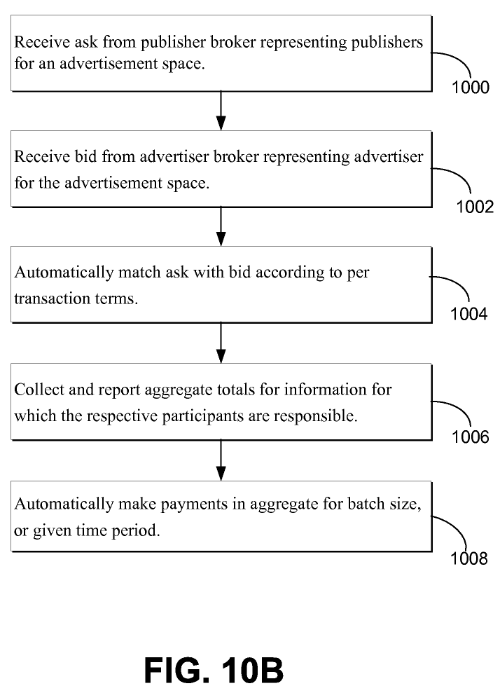

FIG. 10A is a block diagram illustrating the formation of a group 1000 of trusted entities via an exchange tool 1002. As part of formation, each participants specifies a set of reporting capabilities with respect to various pertinent metrics for different billing models depending on their role in the advertising food chain, and each party ultimately designates a set of metrics to report respecting transactions 1004 pertinent to members of the exchange. Collectively, the set of metrics to be reported by all of the members of the trusted group 1000 must represent all of the information needed to perform aggregate or statistical based computations by the exchange. In addition bench marks can be established as described above, with corresponding penalties for breach. Then, in operation, totals or statistical representations, as optimally collected and reported by the parties, are brought together via component 1006, from which billing can be based by billing component 1008.

The invention is further described with reference to the flow diagram of FIG. 10B in which exemplary non-limiting operation of the invention in the context of an online advertising exchange is shown. At 1000, one or more asks are received from publisher brokers representing publishers for advertisement space(s). At 1002, one or more bids are received from advertiser brokers representing advertisers for the advertisement space(s). At 1004, one or more ask(s) are automatically matched to one or more bid(s) according to per transaction terms. Then, at 1006, in accordance with the invention, rather than require transaction level reporting, aggregate totals and/or statistical representations for metrics or information are collected with respect to transactions conducted pursuant to transaction terms. Then, at 1008, payments are automatically made to the appropriate participants in aggregate according to batch size, or according to statistical or probabilistic extrapolation by the exchange.

Upon the occurrence of user events, such as entering search terms, or clicking on an advertisement, in order to properly award the cost of the advertising event to the appropriate publishing entities, market makers, etc., a variety of information is recorded, such as, but not limited to, when the event occurred, from what machine the request occurred, whether the event resulted in a sale or customer, how long the user spent at the target content, information about the user, etc. Such information may or may not all be directly relevant to the transaction model upon which the cost apportionment is based, but may also be relevant to future advertising efforts, and to detecting fraud on the event, such as click fraud.

Thus, where in the past, the processing of N entities has been performed per transaction, or impression, with the invention, when only two or a small number of trusted parties are involved in transactions via OLX, batching of transactions can occur, e.g., in aggregate or according to probabilistic representation.

Decentralizing the problem of fraud detection and placing it into the trusted hands of those who are most expert to make fraud determinations enables a more cost effective and efficient data collection process, benefiting all. The invention thus recognizes that where two parties trust one another because both benefit from cooperation, then those two parties can apportion the tasks of transaction reporting in a much more efficient manner. Together, a cooperative set of reporting by the publisher and advertiser provides each other with enough information to understand the event without requiring transaction level details in the case of every transaction by both the publisher and the advertiser.

Accordingly, in various non-limiting embodiments, the invention provides infrastructure for an on-line advertising marketplace for a subset of parties, e.g., 2 or more, to engage under trusted reporting circumstances, whereby the parties that are best positioned to collect information about fraud are designated to collect such information. The infrastructure can be manifested as part of an advertising exchange by providing a layer where a set of trusted parties can organize according to different reporting requirements than the rest of the transactions conducted in the exchange.

Periodically, such as at the end of each day, aggregate totals for transactions for the period are reported, either as a direct calculation by those best positioned to provide the aggregate totals, or on a statistical basis, taking into account probability of fraudulent transactions. Such aggregate totals or statistical reporting substantially alleviate onerous reporting requirements and still operate to safeguard against fraud.

Moreover, bench marks can also be implemented to compare aggregate reported data with other similar or like data as a deterrent against defrauding a trusted partner. Since an online advertising exchange observes a lot of transactional information, where aberrant statistical data is observed in reported data, the neutral exchange can flag the data for an investigation. Where a trusted partner is found to engage in fraud knowingly, penalties can be applied to the offending party. Advantageously, by merely reporting aggregate totals, rather than all details surrounding a transaction, in some cases, a participant can keep competitive information secret that the participant may not otherwise wish to disclose.

Accordingly, an advertising exchange process is enabled that incorporates the notion that there is a higher degree of trust among just two (or a small number of) players than when N players are involved where N is large. With just two or a small number of players, due to the increased trust, aggregation or batching of transactions across time can occur instead of more tedious tracking of each impression. Whether aggregation occurs can be based on probabilities or statistics as well. For instance, if the expense of overseeing individual transactions is high, then the participant may switch to a probabilistic basis to reduce accounting overhead and costs.

### Exemplary Operating Environment(s)

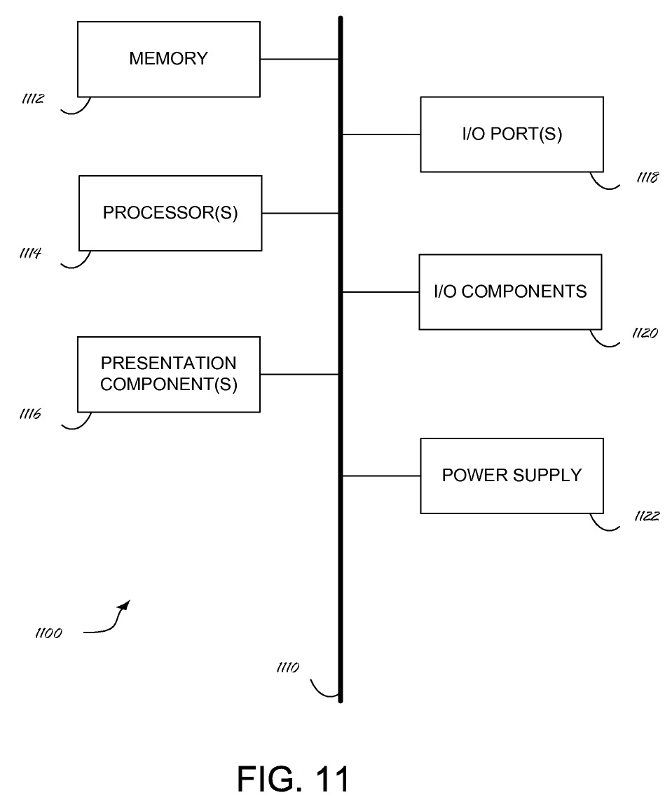

Referring initially to FIG. 11 in particular, an exemplary operating environment for implementing embodiments of the present invention is shown and designated generally as computing device 1100. Computing device 1100 is but one example of a suitable computing environment and is not intended to suggest any limitation as to the scope of use or functionality of the invention. Neither should the computing-environment 1100 be interpreted as having any dependency or requirement relating to any one or combination of components illustrated. In accordance with the invention, participants can communicate with an advertising exchange via one or more computing devices 1100, and the advertising exchange may also comprise one or more computing devices 1100, in order to carry out one or more aspects of the invention described in detail below.

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 11, computing device 1100 includes a bus 1110 that directly or indirectly couples the following elements: memory 1112, one or more processors 1114, one or more presentation components 1116, input/output ports 1118, input/output components 1120, and an illustrative power supply 1122. Bus 1110 represents what may be one or more busses (such as an address bus, data bus, or combination thereof). Although the various blocks of FIG. 11 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 11 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 11 and reference to “computing device.”

Computing device 1100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 1100.

Memory 1112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which may be built in. Illustrative components include a microphone, joystick, game pad, satellite dish, scanner, printer, wireless device, etc.

### Exemplary Architecture(s) for Online Advertising

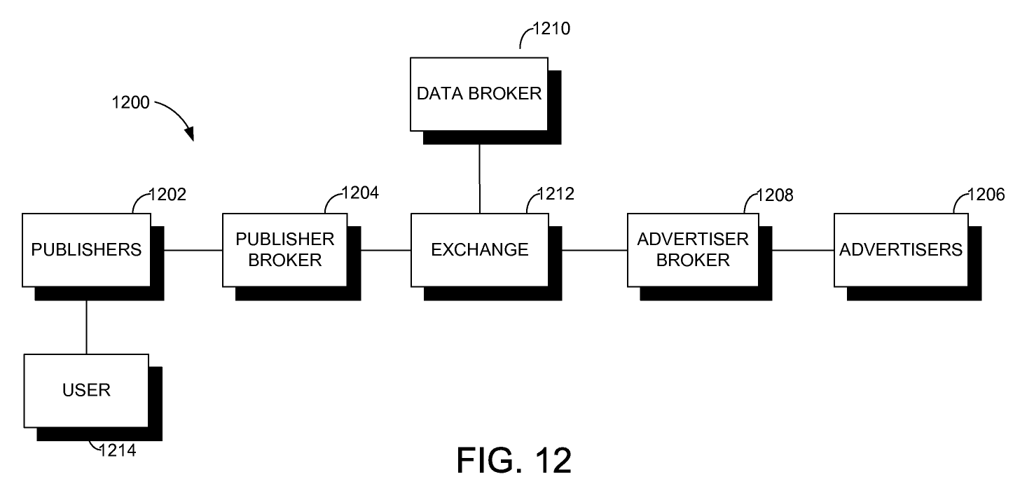

Exemplary online advertising environments or architectures in which one or more of the various embodiments of the specification and normalization of participant tax rates, and intelligent automation of tax rate selection of the present invention may be deployed or implemented are now described. For instance, FIG. 12 illustrates an exemplary distributed architecture 1200 for online advertising, which comprises publishers 1202. For purposes of explanation only, publishers 1202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 1200.

In an embodiment, each publisher is a content provider. For example, a construction worker who operates a single page website on which he posts a weblog (blog) may be a publisher. In another example, a media company such as Disney, who operates a huge website with many pages of content may also be a publisher. Publishers 1202 is intended to represent any number of types, sizes, sophistication levels, etc. of publishers. Size of participants in the exchange can be determined by any method for assigning a size to an entity in a transaction. For instance, size can be determined as a function of revenue or income of the participant, a function of the number of employees of the participant, a function of annual advertising expenditure, a function of growth rate, and so on, as well as a combination of any of the foregoing, i.e., any metric that tends to indicate influence of a participant based on relative size can be used. In an embodiment, publishers 1202 desire to sell advertisement space on their websites to advertisers 1206 (discussed below).

Architecture 1200 also comprises publisher broker 1204. For purposes of explanation only, only one publisher broker will be discussed herein. However, embodiments of the present invention are not limited to a single publisher broker, as any number of publisher brokers may exist. In an embodiment, publisher broker 1204 is an aggregator of publishers. Specifically, publisher broker 1204 is an entity that represents publishers 1202 with the goal of maximizing ad revenue, ensuring quality ads, etc. Publisher broker 1204 breaks the conflict of interest that is inherent in systems such as Google's AdSense by solely focusing on managing publishers 1202's yield. Publisher broker 1204 allows small and mid-size publishers (such as those that may be represented by publishers 1202) to aggregate in order to drive higher yield for themselves. In an embodiment, publisher broker 1204 maintains a user interface through which it interacts with publishers 1202 and through which it manages publishers 1202's preferences.

In an embodiment, publisher broker 1204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc.

The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. Finally, the publisher broker encodes this information into a request URL that it sends back to the user as a redirection URL. When all transactions have occurred in the exchange (see below), a call back is provided to the publisher broker stating whether and how many ads were displayed and what the publisher broker can expect in terms of a payment.

Architecture 1200 also comprises advertisers 1206. For purposes of explanation only, advertisers 1206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 1200.

In an embodiment, each advertiser purchases ad space on websites. For example, a local businessperson who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 1206 is intended to represent any number of types, sizes, sophistication levels, etc. of advertisers. In an embodiment, advertisers 1206 desire to pay money to place ads on publishers 1202's websites.

Architecture 1200 also comprises advertiser broker 1208. For purposes of explanation only, only one advertiser broker will be discussed herein. However, embodiments of the present invention are not limited to a single advertiser broker, as any number of advertiser brokers may exist. In an embodiment, advertiser broker 1208 is an aggregator of advertisers. Specifically, advertiser broker 1208 is an entity that represents advertisers 1206 with the goal of optimizing advertisers 1206's spending and placing monetary values on displaying advertising of a particular format, on a particular website, to a particular audience. In an embodiment, advertiser broker 1208 maintains a user interface through which it interacts with advertisers 1206, and through which it manages advertisers 1206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. In an embodiment, the exchange (see below) carries enough information to allow for advertisers to setup self-optimizing campaigns based only on landing URLs, creatives, and campaign goals. Similarly, algorithms can be run on advertiser landing URLs to choose possible subsets of audience attributes as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track conversions and maximize the number of high value conversions for the existing advertiser budget.

Architecture 1200 also comprises exchange 1212. Exchange 1212 acts as a mediator between publisher broker 1204 and advertiser broker 1208. In an embodiment, exchange 1212 routes traffic and facilitates transactions, e.g., auctions, between publisher broker 1204 and advertiser broker 1208. In an embodiment, exchange 1212 is a server or a set of servers.

To provide minimum standards of conformity, in an embodiment, exchange 1212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an embodiment, exchange 1212 sends all publisher broker requests that match a set of criteria defined by the advertiser broker, along with all relevant data about the request (e.g., the ask and collection symbols provided by the publisher and the exchange itself). In an embodiment, if the advertiser broker has any ads that it would like to have displayed and that meet the ask, it returns those ads, up to the number of ads requested, along with a CPI (cost per impression) bid on each. It is noted that CPM (cost per thousand impressions) and CPI are equivalent pricing models with different acronyms. However, embodiments are not limited to CPI pricing, as other pricing models may be used, e.g., CPC (cost per click), CPI (cost per impression), CPA (cost per acquisition), and revenue sharing. Exchange 1212 provides a call back to the winning advertiser broker(s) telling it which ads were displayed, and at what prices.

Architecture 1200 also comprises users 1214. For purposes of explanation only, only one user will be discussed herein. However, embodiments of the present invention are not limited to a single user, as any number of users may exist. Users 1214 request a webpage from publishers 1202. The webpage comprises content and advertisement space, which is filled with advertisement(s) from advertisers 1206.

Using architecture 1200, audience data can be provided to advertisers 1206 either by enriching the publishing property with customer intelligence or by acquiring the data directly from a data broker 1210 based on a licensing fee. For instance, advertiser broker 1208 can choose to pay an estimated monthly per volume amount for each attribute that their advertisers are interested in targeting. This transaction could be done off-line but would need to be registered with exchange 1212 to facilitate data rerouting at request time. Advertiser broker 1208 can base its bids on any targeting attributes provided by data broker 1210.

In an embodiment, when publishers 1202 have an impression that they are willing to sell (with an optional ask), they can provide a URL and any targetable values to exchange 1212. Exchange 1212 passes this data and possible additional user data from data broker 1210 to advertiser broker 1208. In an embodiment, advertiser broker 1208 ranks the bids of advertisers 1206 using any proprietary attributes or techniques that it finds useful. For example, advertiser broker 1208 could choose to run keyword extraction or categorization and use this for targeting. Advertiser broker 1208 would output a CPI ranked list of advertisers (in an embodiment, the number would be equal to the number of ads requested by the publisher). In an embodiment, where multiple advertiser brokers exist, exchange 1212 then ranks all ads across all advertiser brokers and chooses the best one (as measured by CPI). If these ads meet or exceed the publisher ask, then exchange 1212 proxies a display of the ads on the publisher website.

A second-price auction can still be applied to facilitate aggressive bidding. Publishers 1202 can be paid on a CPI basis. In an embodiment, exchange 1212 may be used to gate user information originating from publishers 1202. Publishers 1202 can choose to enrich their property with user data and share this information only with selected advertiser brokers.

Because publishers 1202 are concerned with user satisfaction, they would prefer to have some control over the relevancy of the ads placed on their site. Click-through rate is considered a good measure of relevance and therefore many publishers might want minimum click-through guarantees on the ads. Exchange 1212 allows publishers 1202 to optionally specify a minimum click-through rate that is acceptable. Exchange 1212 monitors advertiser broker 1208 to make sure that if it wins these types of asks, then it is meeting the performance guarantees. In an embodiment, if an advertiser broker consistently provides low click-through rates for publisher asks that require a minimum, exchange 1212 may take punitive measures such as suspension from the system.

Advertiser broker 1208 is responsible for converting any externally facing pricing models it allows into the CPI bid on each request. For example, a simple CPC to CPI conversion would be to multiply the per click bid of each ad by the expected click through rate of the ad for the conditions present. Similarly, to convert a CPA bid to CPI, advertiser broker 1208 could multiply the conversion rate by the per conversion bid of the advertiser. The more information available in each request, the better job advertiser broker 1208 can potentially do in predicting the probability of a click or a conversion.

The entity hosting exchange 1212 has access to all data sources, giving it the power to make partial decisions. To alleviate the concern that exchange 1212 will not be impartial both as hosting body and as a direct participant, in an embodiment, transparency will be built into exchange 1212. In that embodiment, exchange 1212 does not have a way to identify brokers of any kind. Also, in that embodiment, advertiser auction algorithms and advertiser to publisher matching algorithms are standardized and transparent to all exchange participants. In an embodiment, no user identifiable information is sent to advertisers 1206 until the user performs an action. Exchange 1212 passes advertiser broker 1208 only the attribute values. Advertisers 1206 do not see the user identifier. At click-time, however, it is still possible for an advertiser to establish a user identifier and associate the bidding profile with that user. For example, exchange 1212 could require a linear value function, and advertisers 1206 would specify a base bid and a bid increment for each attribute value.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who recently have purchased books on vacations and users who perform searches related to travel. Expedia decides to license user information from Amazon, MSNSearch, and Orbitz. Expedia agrees to pay Amazon 1 cent for using their user information for each ad impression. Similarly, Expedia agrees to pay 1 cent to MSNSearch and 3 cents to Orbitz.

For the “cheap Bali vacations” ad, Expedia creates a targeting profile for users who: “bought a book on Bali in the last month,” “Have traveled to a tropical location in the last two years,” “Have household income between $30,000 and $60,000,” “Have been searching for vacation deals,” and “Have ever clicked on ads.” Expedia places a 20 cent base bid. To express their bidding preference, they also place a 5 cent incremental bid for the first attribute, a 10 cent incremental bid for the second attribute, a 2 cent incremental bid for the third attribute, 1 cent incremental bid for the fourth attribute, and a 2 cent incremental bid for the fifth attribute to express their bidding preference. Borders as a publisher has a user requesting the page on the “Lonely Planet Guide to Indonesia” and they would like to show ads on that page. They call exchange 1212 with the page URL and information about the user: “Bought four travel books in the last month,” “Bought a book on Bali in the last month,” and “Has clicked on ads before.”

Given the URL, exchange 1212 extracts keywords (“Bali vacations,” “Indonesia travel,” “exotic vacations,” “beach vacations”) and categories (“travel,” “vacations”), and sends this information to each advertiser broker. Each advertiser runs an auction for the impression. The advertiser broker can choose to ask for aggregate bids from advertisers. For example, Expedia might place an aggregate bid of 24 cents, and after subtracting the licensing fees, their base bid would be equal to 20 cents. Expedia's advertiser broker needs first to subtract all incremental bids and to assign credit to the publisher as appropriate. For example, Expedia's 5 cent incremental bid for “bought a book on Bali in the last month” and their 2 cent incremental bid for “Have ever clicked on ads” will be assigned to the publisher. The value for “Have traveled to a tropical location in the last two years” attribute is provided by Orbitz so the 10 cent incremental bit would be assigned to them. The publisher was not able to assess the household income of the user so this incremental bid is not used. The 1 cent incremental bid for the search user patterns will be credited to MSNSearch. After the appropriate credit distribution the advertiser broker would assign a publisher value bid (the base bid+any incremental publisher bids) to each advertiser. In case of Expedia publisher value bid would be equal to 27 cents. Given that Expedia's bid is CPC based, the advertiser broker needs to convert it to a CPI one before running an auction and selecting the best ads to send to the exchange. Expedia's advertiser broker knows that this specific ad is likely to get a 10% CTR, and thus for ranking purposes, Expedia is assigned a 2.7 cent CPI bid. If Expedia wins within its advertiser broker, its ad will be sent for global ranking to the exchange. If Expedia wins the global auction then their advertiser broker is charged 2.7 cents for displaying the Expedia ad. Expedia's ad is served on Border's page. The user clicks on the ad. The user buys a two-week vacation to Bali.

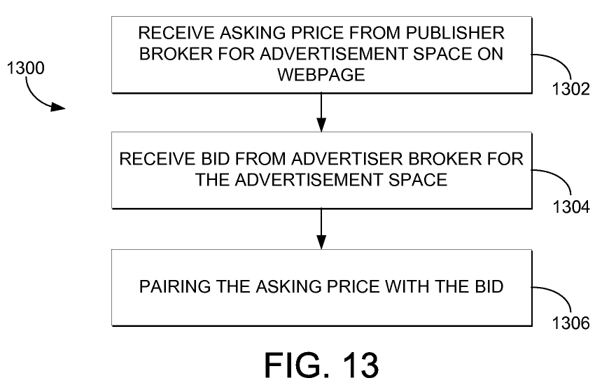

FIG. 13 illustrates a flowchart of the operation of an exchange, according to embodiments of the present invention. Referring to FIG. 13, method 1300 begins with the receipt of an ask from a publisher broker for advertisement space on a webpage (1302). A bid is received from an advertiser broker for the advertisement space (1304). In an embodiment, bids are received from many different advertiser brokers. The ask is paired with one of the bids (1306) and the advertisement space on the webpage is awarded to the winning bidder. As discussed in greater detail above, other information such as user attributes may be attached to the ask, and quality of the bidding advertisers may be examined prior to the advertisement space being awarded.

Accordingly, in non-limiting embodiments, the invention includes a system to facilitate trading of advertising by having a publisher broker to represent publisher(s) that determines an ask for an advertisement space on the publisher(s)' webpages. An advertiser broker also represents advertiser(s) and manages an advertiser(s)' bid for the advertisement space. The exchange of the invention then facilitates transactions for advertisement space between the publisher broker and the advertiser broker.

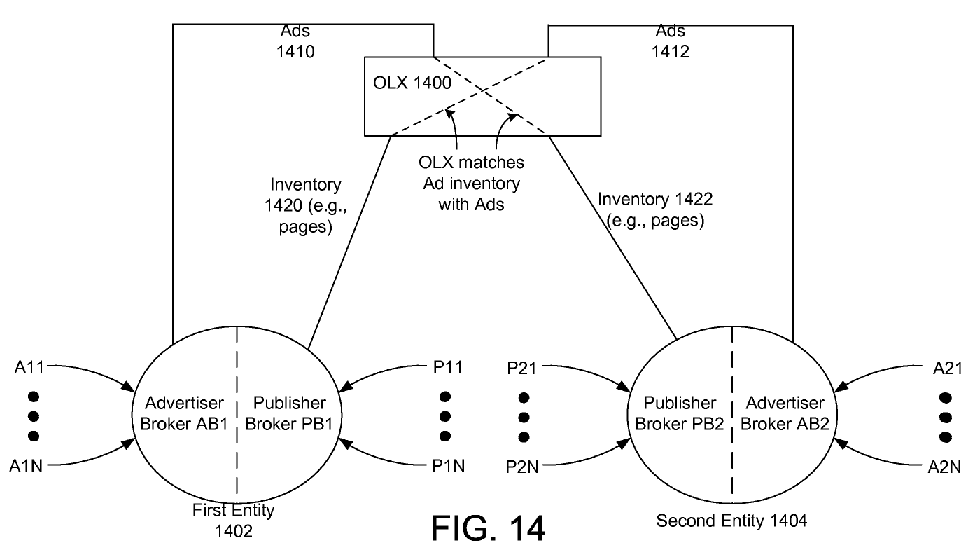

The invention thus can operate in a system that enables broad liquidity over distributed advertising markets, such as the above-described advertising exchange systems. FIG. 14 illustrates a conceptual block diagram of an on-line advertising exchange 1400 provided in accordance with the invention. As shown, a first entity 1402 and a second entity 1404 are subscribers to the services of exchange 1400. First entity 1402 may have an advertiser broker AB1 for brokering advertisements 1410 from a variety of sources A11 thru A1N and a publisher broker PB1 for brokering inventory 1420 from a variety of publishers P11 thru P1N. A goal of ad broker AB1 is to find inventory for existing advertisements. A goal of publisher broker PB1 is to represent publishers, i.e., to help obtain revenue for their inventory (e.g., pages). Similarly, second entity 1404 may have an advertiser broker AB2 for brokering advertisements 1412 from a variety of sources A21 thru A2N and a publisher broker PB2 for brokering inventory 1422 from a variety of publishers P21 thru P2N.

In accordance with the invention, by providing ads 1410 and 1412 to OLX 1400 according to a first communications layer, and by providing inventory 1420 and 1422 to OLX 1400 according to an independent communications layer, OLX 1400 can efficiently match advertisements to available inventory with greater simultaneous knowledge of multiple advertising networks.

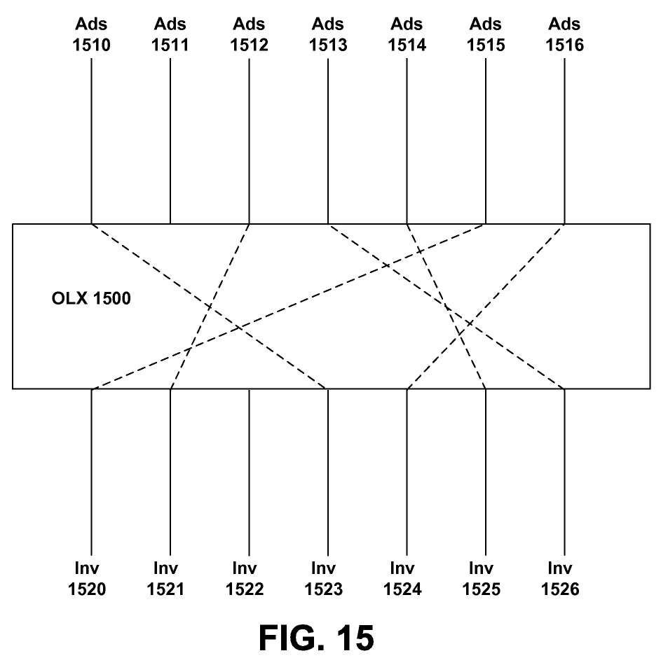

For instance, first entity 1402 might be Microsoft's MSN Web site, and second entity 1404 might be Yahoo's portal Web site. For simplicity, FIG. 14 illustrates only two entities, but advantageously, the invention can also be scaled to accommodate any number of advertising networks, e.g., eBay, Amazon, Google, etc. This is illustrated in FIG. 15 showing an OLX 1500 that accommodates a wide range of advertising 1510, 1511, 1512, 1513, 1514, 1515, 1516, etc. from a wide range of parties, and also accommodates a wide range of inventory 1520, 1521, 1522, 1523, 1524, 1525, 1526, etc. from a wide range of parties. OLX 1500 then makes the best assessment of how to match advertising content with inventory according to a variety of policies (e.g., maximizing ad revenue, maximizing quality of advertising, maximizing conversion rate, etc.). While various non-limiting embodiments of the invention are described in the context of two parties herein, this is for ease of conceptual presentation. It can be appreciated that the invention can be provided for any arbitrary number of advertising entities wishing to join the exchange 1500.

The invention may also be implemented in a peer-to-peer architecture, wherein processing performed by the exchange of the invention is shared across multiple participating machines. In such a non-limiting embodiment, each machine participating in the exchange network enabled by the invention can share some of the processing associated with normalization processes performed by the various embodiments of the on-line exchange of the invention.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method of facilitating trading of advertising, comprising:
receiving an ask from at least one publisher broker for an advertisement space, wherein the at least one publisher broker represents at least one publisher;
receiving a bid from at least one advertiser broker for the advertisement space, wherein the at least one advertiser broker represents at least one advertiser, wherein at least one of the at least one publisher broker and at least one of the at least advertiser broker are from disparate advertising networks;
automatically forming per advertising transaction terms based on a match between the ask and the bid;
receiving, from the at least one publisher broker or the at least one publisher and from the at least advertiser broker or the at least one advertiser, aggregate transaction data representative of a batch of individual advertising transactions occurring according to the per advertising transaction terms; and
apportioning payment among the at least one publisher broker or the at least one publisher and from the at least advertiser broker or the at least one advertiser based on the aggregate transaction data.

2. The method of claim 1, wherein the receiving includes receiving first aggregate transaction data from the at least one publisher broker or the at least one publisher and receiving second aggregate transaction data from the at least advertiser broker or the at least one advertiser, wherein the first aggregate transaction data is not the same as the second aggregate transaction data.

3. The method of claim 2, wherein the apportioning is based on both the first aggregate transaction data and the second aggregate transaction data, either of which alone is insufficient to perform said apportioning.

4. The method of claim 1, wherein the receiving includes receiving totaled transaction data representing at least one totaled measurement made with respect to the individual advertising transactions of the batch of transactions.

5. The method of claim 1, wherein the receiving includes receiving a statistical representation of at least one measurement made with respect to the individual advertising transactions of the batch of transactions.

6. The method of claim 1, wherein the receiving includes receiving a probabilistic representation of at least one measurement made with respect to the individual advertising transactions of the batch of transactions.

7. The method of claim 1, wherein the receiving includes receiving aggregate data concerning at least one aggregate fraud metric for determining a level of fraud represented by the batch of transactions.

8. The method of claim 7, wherein the receiving includes receiving aggregate data concerning at least one aggregate click fraud metric for determining a level of click fraud represented by a batch of transactions triggered by a user click.

9. The method of claim 1, further comprising:
comparing the aggregate data to bench mark data to determine whether the data is significantly aberrant from the bench mark data.

10. The method of claim 9, further comprising:
comparing the aggregate data to performance data tracked for other transactions of the same or similar type to the batch of transactions.

11. A system to facilitate trading of advertising, comprising:
a publisher broker to represent at least one publisher, wherein the publisher broker determines at least one ask for an advertisement space of the at least one publisher;
an advertiser broker to represent at least one advertiser, wherein the advertiser broker manages at least one bid for the advertisement space by the at least one advertiser;
an exchange to facilitate at least one agreement predicated on a cost per advertising transaction billing model for the advertisement space between the publisher broker and the advertiser broker, wherein the publisher broker and the advertiser broker are advertising entities of disparate advertising networks, and
an aggregate transaction data processing component that receives from the publisher broker or the advertiser broker at least one specification of at least one aggregate measurement respecting a set of advertising transactions conducted pursuant to the at least one agreement during a predetermined time period, and makes payment for the set of advertising transactions in part based on the at least one aggregate measurement.

12. The system of claim 11, wherein the cost per advertising transaction billing model is a cost per click billing model.

13. The system of claim 11, wherein the cost per advertising transaction billing model is a cost per impression billing model.

14. The system of claim 11, wherein the cost per advertising transaction billing model is a cost per search result listing billing model.

15. The system of claim 11, wherein the cost per advertising transaction billing model is a cost per customer acquisition billing model.

16. The system of claim 11, wherein the set of advertising transactions conducted during the predetermined time period is the set of advertising transactions conducted during a calendar day.

17. The system of claim 11, wherein the at least one specification of at least one aggregate measurement includes at least one specification of at least one estimate of fraud represented in the set of transactions.

18. The system of claim 11, wherein the at least one specification of at least one aggregate measurement includes at least one specification of statistical data describing the set of transactions.

19. A method for facilitating transactions for advertisement space in an advertising exchange between participants from the advertising side and/or the publishing side and from at least two disparate advertising networks, comprising:
automatically forming agreement terms in the advertising exchange defining advertising payment terms among at least two participants on a per transaction basis; and
optionally selecting a per transaction data reporting method for reporting knowledge of transactions conducted pursuant to the agreement terms on a per transaction basis, or selecting a batch transaction data reporting method for reporting aggregate transaction data representative of a batch of individual advertising transactions; and
depending on the selection, apportioning payment among the at least two participants based on reporting of per transaction data by the at least two participants or based on reporting of the aggregate transaction data by the at least two participants, respectively.

20. The method of claim 19, wherein the selecting of a batch transaction data reporting method includes selecting reporting of statistical descriptions of the batch of individual advertising transactions as a whole.
